(19) United States
(12) Patent Application Publication
(10) Pub. No.: US 2017/0261377 A1
(43) Pub. Date: Sep. 14, 2017

(54) BI-MATERIAL TERAHERTZ SENSOR AND TERAHERTZ EMITTER USING METAMATERIAL STRUCTURES

(71) Applicant: United States of America, as represented by the Secretary of the Navy, ARLINGTON, VA (US)

(72) Inventors: Fabio D. ALVES, Monterey, CA (US); Dragoslav GRBOVIC, Mountain View, CA (US); Gamani KARUNASIRI, Pacific Grove, CA (US)

(21) Appl. No.: 14/978,769

(22) Filed: Dec. 22, 2015

Related U.S. Application Data
(63) Continuation-in-part of application No. 13/851,531, filed on Mar. 27, 2013, now abandoned.
(60) Provisional application No. 61/616,787, filed on Mar. 28, 2012.

(51) Int. Cl. G01J 5/40; G01J 5/10

(52) U.S. Cl. CPC G01J 5/40; G01J 5/10

(57) ABSTRACT

Bi-material terahertz (THz) sensors with metamaterial structures are described. In one embodiment, MEMS fabrication-friendly SiOₓ and Al are used to maximize the bi-material effect and metamaterial absorption at 3.8 THz, the frequency of a quantum cascade laser illumination source. Sensors with different configurations were fabricated and the measured absorption is near 100% and responsivity is around 1.2 deg/μW. Fabrication and use of the sensors in focal plane arrays for real time THz imaging is described. In a further embodiment, the metamaterial structure is utilized as a THz emitter when heated by an external source.

### CROSS-REFERENCE TO RELATED APPLICATIONS

This application is a continuation-in-part application of U.S. patent application Ser. No. 13/851,531, filed Mar. 27, 2013, entitled “Terahertz Sensors and Emitters Using Metafilm Absorbers and Emitters and Their Application to Terahertz Imagers and Projectors” which further claims priority to and the benefit of U.S. Provisional Patent Application Ser. No. 61/616,787, filed Mar. 28, 2012, entitled “Device and Method for Enhancing THz Absorption by Embedding Resonant Metafilms Into Detector in THz-imaging Focal Plane”, the entireties of both applications are hereby incorporated by reference.

### BACKGROUND OF THE INVENTION

1. Field of the Invention

The present invention relates generally to detecting terahertz (THz) radiation, emitting THz radiation, and imaging with terahertz (THz) radiation.

2. Description of the Related Art

Imaging with terahertz (THz) radiation is attractive for security and medical applications due to its ability to penetrate most dry, non-metallic, non-polar materials without damaging them while resolving details that could be concealed in another spectral range, such as skin features and metallic objects. Real-time THz imaging has been demonstrated using conventional, microbolometer-based imagers optimized for infrared (IR) wavelengths (8-12 μm) coupled with a quantum cascade laser (QCL) as an illumination source. The limitations of this approach are the low sensitivity of the microbolometer cameras in the THz region and small pixel size (˜30 μm), compared with THz wavelengths (˜100 μm at 3 THz).

Several bi-material based sensors have been demonstrated for IR detection and imaging. These detectors either use IR sensitive structural materials such as SiNₓ and SiO₂ or, alternatively, integrate separate IR sensitive layers into the detector. Additional difficulties exist when the detection range is extended to the THz region. The low thermal background power in THz demands highly sensitive detectors and, in most cases, external THz illumination is also required.

### SUMMARY OF THE INVENTION

Embodiments in accordance with the invention integrate highly absorbing metamaterial films with bi-material legs to form THz sensors for use in THz sensing and imaging. The design, fabrication, and characterization of highly sensitive micromechanical bi-material THz sensors based on metamaterial structures are further described herein. In various embodiments, a plurality of bi-material THz sensors can be placed in an array to provide a THz imaging function. In a further embodiment, the metamaterial structure can be heated and used as a THz scene emitter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments in accordance with the invention are further described herein with reference to the drawings.

FIG. 1A illustrates a 3D view of a bi-material THz sensor with a metamaterial absorber, fabricated on a Si substrate in accordance with one embodiment.

FIG. 1B illustrates a close up of an isolated bi-material leg of length l_{b}, and metal thickness t₁ and dielectric thickness t₂. Δz_{leg} is the linear deflection and AO is the angular deflection of the bi-material leg in accordance with one embodiment.

FIG. 2A illustrates thermomechanical deflection of the bi-material THz sensor of a freestanding flat THz absorber connected to a bi-material leg, whose length is l_{b}, having a metal thickness t₁ and a dielectric thickness t₂. Δz_{abs} is the total linear displacement and Δθ is the angular deflection of the absorber in accordance with one embodiment.

FIG. 2B illustrates thermomechanical sensitivity (dθ/dT) of the structure of FIG. 2A calculated for all combinations of metal/dielectric of Table 1 where t₁ varies from 10 to 800 nm and t₂ is fixed in 1.1 μm in accordance with one embodiment.

FIG. 3A illustrates the schematics of a metamaterial unit cell within a metamaterial absorber of a periodic array of Al square elements separated from an Al ground plane by a SiOₓ layer in accordance with one embodiment.

FIG. 3B illustrates metamaterial array test structure having a plurality of metamaterial unit cells with 20 μm period and varying square dimension (s), fabricated in a Si substrate in accordance with one embodiment.

FIG. 4A illustrates finite element (FE) modeling of a metamaterial unit cell using a COMSOL Multiphysics RF module and unit cell simulation parameters in accordance with one embodiment.

FIG. 4B illustrates finite element modeling of a metamaterial unit cell using a COMSOL Multiphysics RF module in which the arrows (proportional plot) represent the anti-parallel surface currents excited in the two metallic layers in the metamaterial unit cell, while the surface colors represent the electric field magnitude in accordance with one embodiment.

FIG. 5A illustrates finite element simulations of a metamaterial unit cell using a COMSOL Multiphysics RF module in which the surface colors represent the resistive loss in the structure where blue represents no loss in accordance with one embodiment.

FIG. 5B illustrates finite element simulations of a metamaterial unit cell using a COMSOL Multiphysics RF module showing a comparison between measurement (solid lines) and FE simulations (dashed lines) of absorptance of three metamaterial structures fabricated with the same repetition period (20 μm) and different square sizes in accordance with one embodiment.

FIG. 6A illustrates structural parameters of a first bi-material THz sensor showing all dimensions in accordance with one embodiment.

FIG. 6B illustrates structural parameters of a second bi-material THZ sensor in accordance with one embodiment.

FIG. 6C illustrates structural parameters of a third bi-material THz sensor in accordance with one embodiment.

FIG. 6D illustrates a vertical cut of the sensor structure found in the bi-material THz sensors of FIGS. 6A, 6B and 6C in accordance with one embodiment.

FIG. 7A illustrates an FE simulation showing the deformation plot of bi-material THZ sensor A under a constant 1 μW heat flux in accordance with one embodiment.

FIG. 7B illustrates an FE simulation showing the deformation plot of bi-material THZ sensor B under a constant 1 μW heat flux in accordance with one embodiment.

FIG. 7C illustrates an FE simulation showing the deformation plot of bi-material THZ sensor C under a constant 1 μW heat flux in accordance with one embodiment.

FIG. 7D illustrates a time domain simulation of bi-material THZ sensors A, B, and C illustrated in FIGS. 7A, 7B, and 7C, respectively, under a 1 μW step excitation (black line) in accordance with one embodiment.

FIG. 8A illustrates a 3D optical profile of a fabricated bi-material THz sensor A with the aspect ratio is preserved in accordance with one embodiment.

FIG. 8B illustrates a micrograph of an array formed of a plurality of the bi-material THz sensor A of FIG. 8A in accordance with one embodiment.

FIG. 8C illustrates a 2D profile taken along the bi-material legs direction (y-profile) with the processing direction (z-profile) scale exaggerated to show the residual deflection of the legs (red line) and absorber (blue line) in accordance with one embodiment.

FIG. 8D illustrates micrographs showing top views of bi-material THz sensors A, B, and C in accordance with one embodiment.

FIG. 9A illustrates measurement of the absorptance spectra of the bi-material THz sensors metamaterial structure (blue line) compared with the QCL normalized emission (read line) in accordance with one embodiment.

FIG. 9B illustrates measured angular deflection (markers) upon temperature change in accordance with one embodiment.

FIG. 10A illustrates measured angular deflection per varying incident power for bi-material THz sensors A, B, and C (colored markers) in accordance with one embodiment.

FIG. 10B illustrates measured output voltage of the position sensitive detector (PSD) for bi-material THz sensor A by gating the QCL output at 200 mHz in accordance with one embodiment.

FIG. 11A illustrates time responses of bi-material THz sensors A, B and C measured under the same incident power with the QCL gated at 1 Hz in accordance with one embodiment.

FIG. 11B illustrates normalized frequency responses for bi-material THz sensors A, B, and C (colored lines) in accordance with one embodiment.

FIG. 12A illustrates an optical readout used to record videos of QCL beam imaging and the snap shot shown in FIG. 12C in accordance with one embodiment.

FIG. 12B illustrates an image obtained using a 30 μm pitch commercial IR microbolometer camera with THz optics.

FIG. 12C illustrates an image of the same QCL beam, obtained using an array of a plurality of bi-material THz sensors A with 430 μm pitch using the readout depicted in FIG. 12A in accordance with one embodiment.

FIG. 12D illustrates a close up of bi-material THz sensor A deformed due to THz absorption of a QCL beam, gated at 0.5 Hz in accordance with one embodiment.

FIG. 13 illustrates the measured emissivity of metamaterial samples A, B and C at 400° C. in which emissivity exhibits peaks at 4.1, 5.4 and 7.8 THz, respectively in accordance with one embodiment.

FIG. 14 illustrates the spectral irradiance of Sample A, measured at 140, 280 and 400° C. in which the inset shows that the measured peak emission (solid squares) depends linearly with temperature (solid line) in accordance with one embodiment.

FIG. 15 illustrates the radiant existence of the dual band metamaterial (sample D) at 400° C. in which the dashed line represents the blackbody curve at the same temperature. The inset shows the metamaterial pattern with two different size squares (10 and 18 μm) distributed in a tile like arrangement.

### DETAILED DESCRIPTION OF THE INVENTION

Generally viewed embodiments in accordance with the invention include a bi-material THz sensor having a metamaterial absorber for absorbing incident THz radiation and converting the radiation to heat. The metamaterial absorber is connected to bi-material legs which deform due to the change in temperature. The bi-material legs are thermally insulated from a host substrate, i.e., a heat sink, by supporting anchor structures of lower thermal conductance. As the metamaterial absorber and bi-material legs deform from an at rest state, an optical reader is used to measure the absorption. This combined configuration of a highly absorbing metamaterial absorber into a bi-material THz sensor has potential in THz sensing and imaging. Herein is further described the design, fabrication, and characterization of various embodiments of the highly sensitive micromechanical bi-material THz sensors based on metamaterial structures and a bi-material THz sensor array for imaging purposes. In a further embodiment, the metamaterial absorber structure when heated can be used as THz emitter.

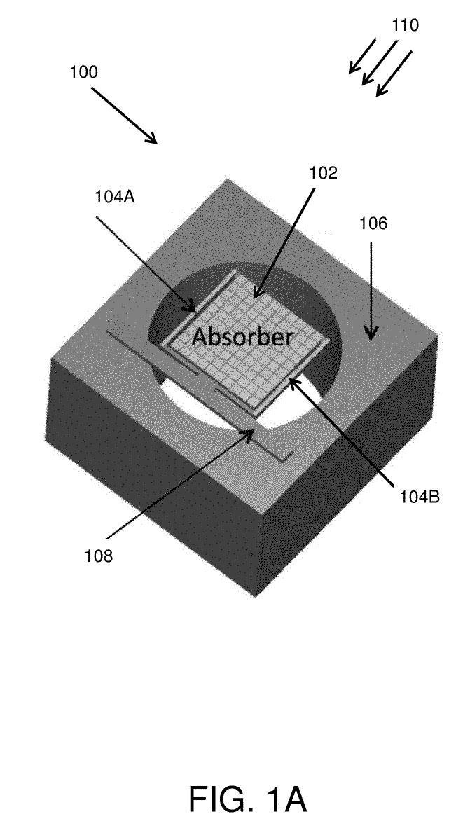

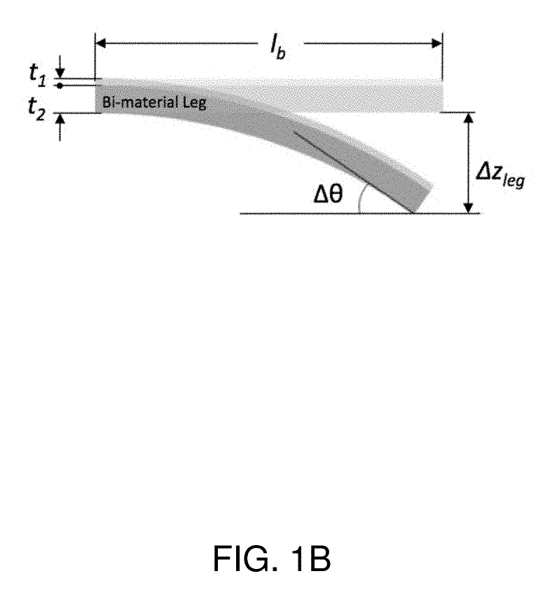

FIG. 1A illustrates a bi-material THz sensor 100 including a metamaterial absorber 102 in accordance with one embodiment of the invention. In one embodiment metamaterial absorber 102 is a sensing element responsible for converting incoming radiation to heat which is transmitted by conduction to two symmetrically located bi-material legs 104A, 104B connected to a host substrate 106 by one or more anchors 108 which are supporting structures of lower thermal conductance. In the present embodiment, host substrate 106 acts as a heat sink. Bi-material legs 104A, 104B undergo bimetallic deformation due to the temperature rise upon absorption of incident radiation 110. The deformation can be probed by different approaches such as piezoresistive, capacitive and optical readouts. The latter requires a reflective surface, in one embodiment provided by the ground plane of the metamaterial structure, and has the advantage of avoiding the complex on-chip integrated microelectronics necessary for other approaches. In one embodiment, the optical readout can be taken from the backside of the ground plane.

For imaging applications, important sensor characteristics are high responsivity, fast operation and low noise. In thermal detectors, sensitivity and speed are controlled by heat capacitance (C) and thermal conductance (G) of the sensor in addition to the efficiency of absorption of incident radiation. Conventional detectors are typically designed to have thermal conductance close to that due to radiation losses. Thermal conductance due to convection is dependent on the pressure of the surrounding gas and can be minimized by operating the detectors at a relatively low pressure.

Solving the heat balance equation under incident radiation modulated at frequency co yields:

$$dT = \frac{η {P}_{0}}{G \sqrt{1 + {ω}^{2} {τ}^{2}}} , \qquad ( 1 )$$

where, dT is the amplitude of temperature change of the sensor, P₀ is the amplitude of the incident power, η represents the fraction of incident power absorbed by the sensor, and τ(=CIG) is the thermal time constant. The responsivity (R) of a bi-material THz sensor can be defined as angular deflection per unit incident power (dθ/dP), which is given by:

$$\frac{d θ}{dP} = \frac{η }{G \sqrt{1 + {ω}^{2} {τ}^{2}}} \frac{d θ}{dT} , \qquad ( 2 )$$

where, dθ/dT is the angular deflection per unit temperature (thermomechanical sensitivity). The speed of the sensor is primarily limited by the thermal time constant. Noise in bi-material sensors arises from several different sources such as temperature fluctuations, background fluctuations, thermo-mechanical resonances, illumination source fluctuations and the readout system. The first four manifest as fluctuations in the overall sensor deflection, while the readout noise depends on the probing mechanism. In a practical sense, the total noise of the complete detection system can be described by the noise equivalent power (NEP). For bi-material sensors, NEP can be defined as the incident radiant power that produces an angular deflection equal to detector's root mean square (rms) noise.

Fundamentally, there are two main choices when designing a bi-material sensor: materials and configuration. Materials should be fabrication-friendly, exhibit low residual stress and have very different thermal expansion coefficients. Configurations should have a large absorption area, good thermal isolation to increase sensitivity, and provide a reflective surface for optical readout. All of these requirements are intrinsically interdependent making the optimization of the final sensor highly dependent on the intended application. Nonetheless, the quest to achieve high performance THz bi-material detectors starts with dθ/dT, defined by the bimetallic effect, and η, which is maximized by the integration of metamaterial structures.

To increase sensitivity, it is important to optimize the bi-material layer thicknesses to maximize the deflection under increasing temperature. Referring now to FIGS. 1A and 1B, if the linear displacement (Δz_{leg}) of the free tip of a bi-material leg, such as 104A, 104B is much smaller than the length of the bi-material leg (l_{b}), the angular deflection due to temperature change (dθ/dT) or thermomechanical sensitivity can be estimated using:

$$\frac{d θ}{dT} = 6 {l}_{b} ( {t}_{1} + {t}_{2} ) {{t}_{2}^{- 2} ( 4 + 6 \frac{{t}_{1}}{{t}_{2}} + 4 \frac{{t}_{1}^{2}}{{t}_{2}^{2}} + \frac{{t}_{1}^{3}}{{t}_{2}^{3}} \frac{{E}_{1}}{{E}_{2}} + \frac{{t}_{2}}{{t}_{1}} \frac{{E}_{2}}{{E}_{1}} )}^{- 1} ( {α}_{1} - {α}_{2} ) , \qquad ( 3 )$$

where t represents thickness, α is the thermal expansion coefficient and E is the Young's modulus. The indices 1 and 2 are used to represent materials 1 and 2, respectively.

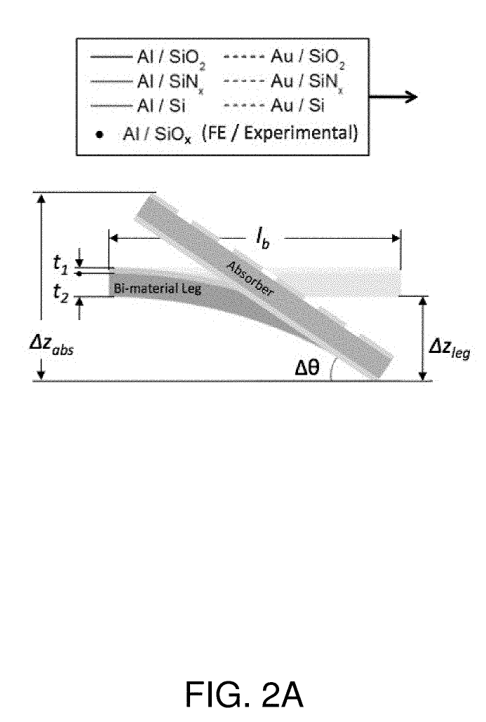

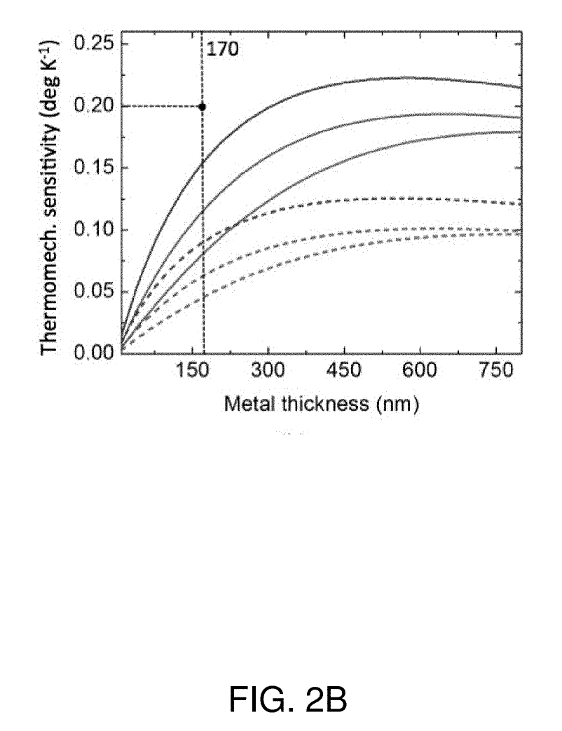

Referring now to FIG. 2A, when bi-material legs 104A/104B are connected to a freestanding flat absorber, the sensor angular deflection is approximately equal to Δθ (see FIG. 1B). The effect can be further amplified by adding multifold legs with alternate bi-material segments. However, such a configuration also magnifies the bending due to residual stress after release. Table 1 lists some of the most common MEMS materials along with their structural, thermal and electrical characteristics.

TABLE 1
Properties of standard MEMS materials^{a}.

| | | | | | | Electric | THz |
|---|---|---|---|---|---|---|---|
| | Young's | Expansion | Thermal | Heat | Density | Conductivity | refractive |
| | Modulus | Coefficient | Conductivity | Capacity | ρ (×10⁻³ kg | σ (×10⁶ S | index^{b} |
| Material | E (×10⁶ Pa) | α (×10⁻⁶K⁻¹) | g (Wm⁻¹ K⁻¹) | c (J kg⁻¹ K⁻¹) | m⁻³) | m⁻¹) | n* |
| Si | 100 | 2.7 | 130 | 750 | 2330 | — | 3.48-0.01i |
| SiNₓ | 180 | 2.1 | 19 | 691 | 2400 | — | 2.1-0.025i |
| SiO₂ | 68 | 0.4 | 1.4 | 703 | 2200 | — | 2.0-0.02i |
| Al | 70 | 25 | 237 | 900 | 2700 | 10 | — |
| Au | 77 | 14.2 | 296 | 129 | 19300 | 37 | — |

^{a}From J. App. Phys. 104(5), 054508 (2008).
^{b}From App. Opt. 46(33), 8818-8813 (2007).

FIG. 2B shows the angular deformation calculated using Eq. (3) for the structure depicted in FIG. 2A for different combinations of metal/dielectric in Table 1, where the length of the leg is fixed to 214 μm, the dielectric thickness is kept constant at 1.1 μm and the metal thickness is varied from 10 to 800 nm. Finite element (FE) simulation and experimental results for t₁=170 nm show that the analytical model slightly underestimates the bimetallic effect (circular marker in FIG. 2B) for this specific configuration.

It is clear from FIGS. 2A, 2B that the Al/SiO₂ combination produces the highest sensitivity with the maximum occurring when the metal thickness is approximately one-half of the dielectric thickness. Non-stoichiometric SiNₓ can provide less stressed layers than SiO₂, however, silicon-rich SiOₓ can be deposited with much lower stress than SiO₂, while preserving most of the thermomechanical and electro-optical properties. During sensor fabrication, testing layers of non-stoichiometric SiOₓ and stoichiometric SiO₂ layers with the same thickness were deposited on Si substrates with intrinsic stress on the order of −13 MPa and −140 MPa, respectively. By selecting SiOₓ and Al (both standard microelectromechanical system (MEMS) materials), it is possible to maximize dθ/dT while simultaneously alleviating some of the excessive residual stress related deformation observed in the sensors fabricated in “Microelectromechanical systems bi-material terahertz sensor with integrated metamaterial absorber,” Opt. Lett. 37 (11), 1886-1888 (2012) by F. Alves, D. Grbovic, B. Kearney, and G. Karunasiri, herein incorporated by reference. Furthermore, SiOₓ and Al exhibit electro-optical properties that are suitable for highly efficient metamaterial absorbers, as further discussed below.

Metamaterial Absorber for THz Frequencies

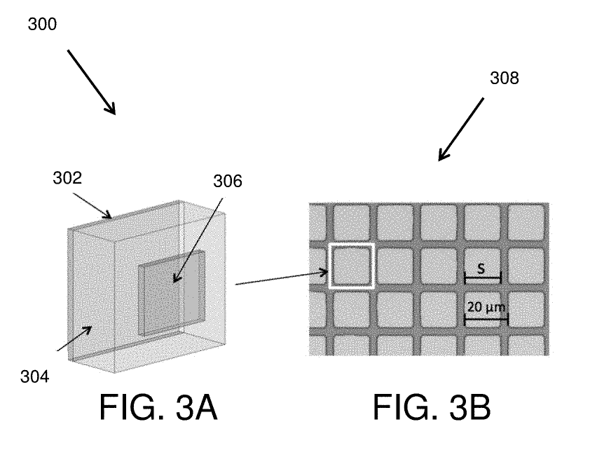

The ability of metamaterials to exhibit absorption characteristics not found in their constituents makes them attractive for fabricating absorbers to integrate into bi-material THz sensors. With the proper structural parameters, a “perfect” absorber can be constructed for a specific narrow band of frequencies. The challenge is to design a metamaterial film thin enough to provide low thermal capacitance, to not degrade the thermal time constant, while providing structural strength, low stress, and a flat reflective surface for an optical readout. In one embodiment, a metamaterial absorber can be designed using a periodic array of a plurality of Al square elements separated from an Al ground plane by a SiOₓ layer, as schematically illustrated in FIG. 3A for a single metamaterial unit cell 300. Such a combination allows matching to the free space impedance at specific frequencies, eliminating the reflection, while the ground plane prevents transmission, resulting in nearly 100% absorption. More specifically, as shown in FIG. 3A, in one embodiment a single metamaterial unit cell 300 includes a ground plane 302 in contact with a spacer 304 in contact with an element 306. In one embodiment, ground plane 302 and element 306 are formed of Aluminum (Al) and are separated by spacer 304 formed of SiOₓ. In one embodiment, Al ground plane 302 is 100 nm thick, SiOₓ spacer 304 is 1.1 μm thick, and Al element 306 is 100 nm thick. FIG. 3B shows a fabricated metamaterial structure 308 on a silicon (Si) substrate where the location of metamaterial unit cell 300 is highlighted by a white square outline. The present embodiment is provided as one example, and is not intended to limit the scope of the invention to the materials and dimensions presented.

It was determined that for these structures the peak absorption frequency depends on the inverse of the size of the aluminum squares (s). The explanation of this phenomenon is still under debate and there are different theoretical approaches. The physical mechanism of the absorption effect has been explained by the excitation of localized electromagnetic resonances, especially the magnetic resonance, evidenced by the anti-parallel surface currents excited in the two metallic layers. On the other hand, investigation using interference models have shown that the anti-parallel surface currents are reproduced by interference and superposition and there is no magnetic coupling between the top and bottom metallic layers. In addition, transmission line, cavity resonance and Fabry-Perot resonance models have also been proposed. Qualitatively, the interaction of electromagnetic radiation with a metamaterial structure can be described using an equivalent LRC resonator circuit with resonant frequency (=1/\sqrt{Lc}). Since the capacitance depends on s², an inverse linear dependence on size is expected for the resonant frequency, which agrees with the experimental observations.

The relatively complex nature of metamaterial structures makes numerical simulations, generally, the preferred modeling method. The design of the metamaterial structures was performed by finite element (FE) modeling using COMSOL multiphysics software. The periodic nature of the metamaterial structures allows the simulation to be performed in a unit cell with the appropriate boundary conditions. The COMSOL radio frequency (RF) module allows an incident plane wave of THz radiation with a given intensity and propagation direction to penetrate a surface using scattering conditions or be generated on a boundary using ports.

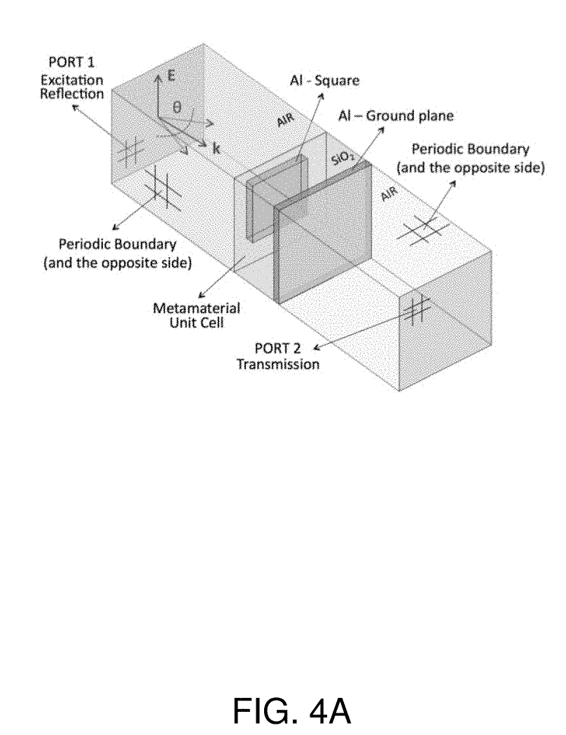

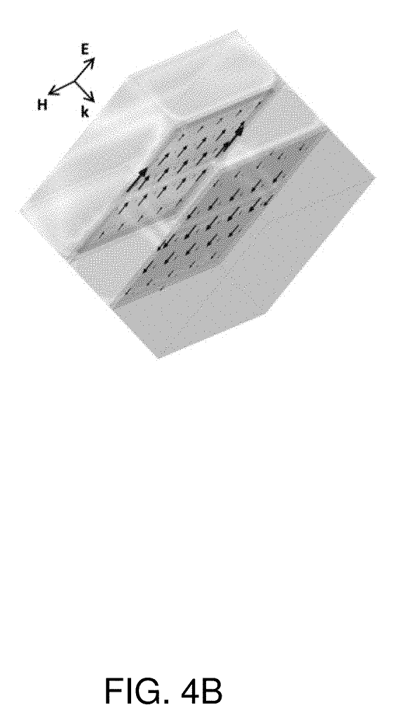

FIGS. 4A and 4B illustrate finite element modeling of a metamaterial unit cell using COMSOL Multiphysics RF module. In FIG. 4A metamaterial unit cell simulation parameters are shown. Two external ports and periodic boundary conditions allow the extraction of the S-parameters and consequently reflection and transmission. Integration of the resistive loss gives the absorbed energy in the metamaterial unit cell. In FIG. 4B the arrows (proportional plot) represent the anti-parallel surface currents excited in the two metallic layers in the metamaterial unit cell, while the surface colors represent the electric field magnitude.

To simulate a metamaterial unit cell, the configuration shown in FIG. 4A was used. Domains other than metal or dielectric were assumed to be free space. Perfect electric conductors (PEC) and perfect magnetic conductors (PMC) were used as periodic boundary conditions for normally incident radiation while Floquet boundary conditions can be used for oblique incidence. The combination of the active port (1) and the passive port (2) allows the scattering parameters in the structure to be determined from which the reflection (R=|S₁₁|²) and transmission (T=|S₂₁|²) can be determined. Finite Element (FE) simulations were performed for Al/SiO₂/Al structures shown in FIGS. 3A, 3B, using parameters listed in Table 1. The arrows (proportional plot) in FIG. 4B represent the anti-parallel surface currents excited in the two metallic layers in the metamaterial unit cell, while the surface colors represent the electric field magnitude. Notice that there is no transmission of the incident wave.

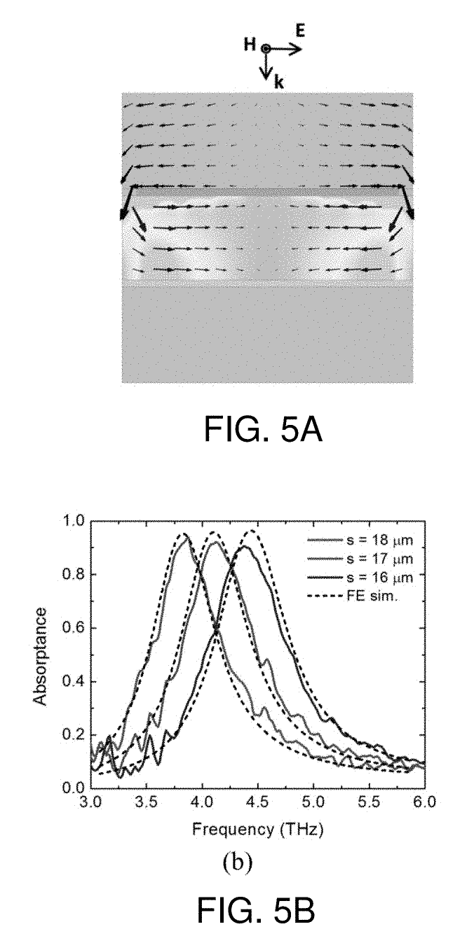

The absorption (A=1−R−T) is the amount of power not reflected (R) and not transmitted (T) due to the negligible contribution of higher order scattering from the metamaterial structure in the simulation. In addition, absorption can be obtained directly by integrating the resistive losses in the unit cell (see surface plot in FIG. 5A). Since all the constitutive relations used in these models are assumed to be linear, it is convenient to set the radiation flux into the metamaterial unit cell to 1 watt, allowing the total resistive losses to simply be read off as absorptance. An additional advantage of integrating resistive losses is that the contribution of individual layers can be examined separately for optimizing the detector design.

FIGS. 5A and 5B illustrate finite element (FE) simulations of a metamaterial unit cell using COMSOL Multiphysics RF module. In FIG. 5A the surface colors represent the resistive loss in the structure where blue represents no loss. The arrows (proportional plot) represent the average power flow in the metamaterial unit cell. Notice that there is no power transmitted. In FIG. 5B a comparison between measurement (solid lines) and FE simulations (dashed lines) of absorptance of three metamaterial structures fabricated with the same repetition period (20 μm) and different square sizes is shown.

FIG. 5A also shows the average power flux (arrows) where no observable flux is found below the metamaterial layer. This indicates that the ground plane is thicker than the skin depth of Al for the simulated frequency range, which is a necessary to obtain absorption close to 100%. A set of metamaterial absorbers consisting of different unit cell configurations was fabricated using Al/SiOₓ/Al layers with standard microfabrication techniques. The details of the fabrication and their absorption characteristics are published in “Microelectromechanical systems bi-material terahertz sensor with integrated metamaterial absorber,” Opt. Lett. 37 (11), 1886-1888 (2012) by F. Alves, D. Grbovic, B. Kearney, and G. Karunasiri, and “Al/SiOₓ/Al single and multiband metamaterial absorbers for terahertz sensor applications,” Opt. Engineering 52(1), 013801 (2013) by B. Kearney, F. Alves, D. Grbovic, and G. Karunasiri, herein incorporated by reference. Reflectance (R) measurements were performed at 15° incidence using a Thermo-Nicolet Nexus 870 Fourier Transform Infrared Spectrometer (FTIR) with a globar source fitted with a PIKE Technologies MappIR accessory. An aluminum-coated Si wafer was used to establish the background for the reflectance measurements. Since the ground plane prevents transmittance, the absorptance can be simplified to A=1−R. FIG. 5B shows the simulated and measured absorption spectra for 3 different structures with periodicity of 20 μm and Al square sizes of 18, 17 and 16 μm. The approximate thickness for both the ground plane and square Al is about 100 nm while the SiOₓ layer is 1.1 μm. The dimensions were selected to give peak absorption close to 3.8 THz, the frequency of a utilized QCL. It can be observed in FIG. 5B that the structure with square size of 18 μm gives peak absorption around 3.8 THz and show absorption peak of 95%, making this configuration the preferred choice for the metamaterial absorber to achieve maximum responsivity. The SiOₓ and top Al layers can be used for making the bi-material legs, simplifying the fabrication process. Additionally, the Al ground plane is an efficient mirror for optical readout of deformation of pixel under THz absorption. The square metamaterial geometry is particularly attractive since the difference in Al coverage on both surfaces of the central absorber is less than 20%. This helps compensate stress, making the mirror relatively flat, improving the efficiency of the optical readout.

Bi-Material THz Sensor Design

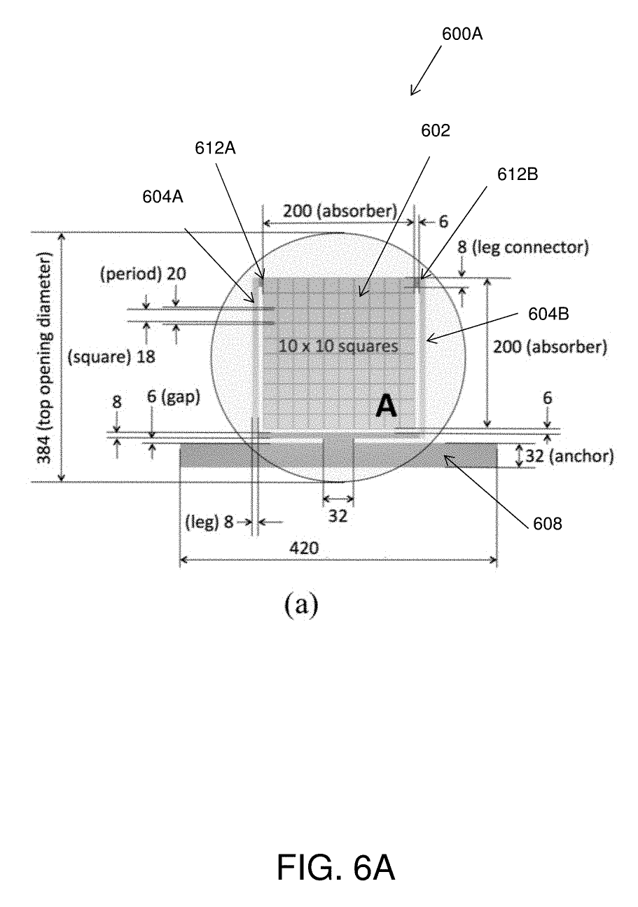

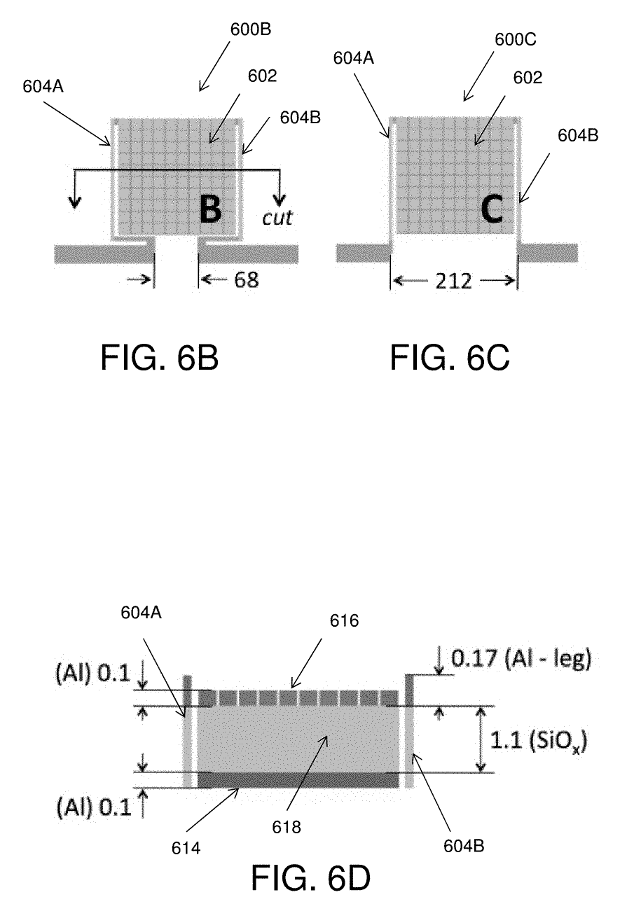

In the following embodiments, bi-material THz sensors were designed using a metamaterial structure optimized to absorb at 3.8 THz. Relatively large pixel dimensions were chosen to increase the absorption area and simplify the fabrication and characterization process. Thermal conductance was intentionally varied among the designs while thermal capacitance remained essentially constant (see Table 2). FIGS. 6A, 6B, 6C show the structural details of three embodiments of bi-material THz sensors, sensor A, sensor B, and sensor C, respectively, with different thermal conductances in accordance with the invention.

FIG. 6A illustrates a top view of a sensor A, bi-material THz sensor 600A, showing various dimensions. FIG. 6B illustrates a top view of a sensor B, bi-material sensor 600B. FIG. 6C illustrates a top view of a sensor C, bi-material THz sensor 600C. FIGS. 6A, 6B, and 6C show differences in sizes of the thermal insulator anchors. FIG. 6D illustrates a vertical cut of the bi-material sensor structure.

Sensors A, B, and C consist of a square metamaterial sensing element in the center, metamaterial absorber 602, connected to two symmetrically located rectangular bi-material legs, bi-material legs 604A, 604B. Note at 612A, 612B the absence of a conductive layer between metamaterial absorber 602 and bi-material legs 604A, 604B. The entire sensor structure (602, 604A, 604B) is then connected to and thermally isolated from the substrate (not shown, but refer to FIG. 1A, substrate 106) by one or more folded SiOₓ anchors 608 with varied dimensions as shown in FIGS. 6A, 6B, 6C. In one embodiment, the thickness of Al ground plane 614 and Al element squares 616 is 100 nm while bi-material legs 604A, 604B have a 170 nm layer of Al on the top side. The structural dielectric SiOₓ is 1.1 μm thick. The thermal conductance (G) of all the sensors A, B, C was estimated using the expression:

$$G = \frac{{g}_{th} {A}_{C}}{l} , \qquad ( 4 )$$

where gₜₕ is the thermal conductivity, A_{C} is the cross-sectional area and l is the length. Since the dimensions of the thermal isolation sections are different, the total thermal conductance was estimated by adding the thermal resistance of each section. The metallized parts are considered thermal shorts due to their high thermal conductivity compared to that of SiOₓ. The heat loss via radiation is found to be an order of magnitude lower than that via the insulating legs due to low emissivity of Al and the THz metamaterial that cover most of the sensor surfaces. Heat dissipation due to convection is negligible as the sensors typically operate under low pressure (in a vacuum sealed package). The thermal capacitance was estimated using the expression:

C=cₜₕρAₛt, (5)

where, cₜₕ is the material thermal capacity, p is the material density, Aₛ is the surface area and t is the structure thickness. The thermal capacitance of the sensor is the sum of thermal capacitances of the SiOₓ and Al layers. The material parameters used for the calculations are given in Table 1. The time constant (τ=C/G) was also estimated for each sensor configuration and listed in Table 2 in addition to other parameters.

The deformation of the bi-material THz sensor structure with increasing temperature was analyzed using the COMSOL heat transfer module, which allows a uniformly distributed heat flux boundary to be placed at the absorber to emulate the incoming THz power. The anchor attachments to the substrate are fixed and set at constant temperature to represent the heat sink. All other boundaries are thermally insulated from the surroundings and free to move. The program computes the heat transfer equation at each mesh point allowing the retrieval of several parameters, such as temperature distribution, thermal deformation, etc. For steady state simulations the total incoming heat flux was conveniently set as 1 μW, therefore the thermal deformation and temperature distribution can be directly read “per unit μW”.

The angular deformation can be directly obtained by the displacement of the free edges of absorber and hence dθ/dT can be estimated using the temperature difference between the absorber and heat sink. Also, the responsivity (dθ/dP) of the sensors can be obtained using the maximum deformation (steady state) and the incident heat flux (1 μW). Furthermore, thermal conductance can be estimated using Eq. (1).

Time domain simulations were performed to obtain the transient response of the bi-material THz sensor structure to a pulsed heat flux allowing the retrieval of the time constant of the sensors. Using the obtained time constant and thermal conductance, the thermal capacitance of the sensors was estimated. The calculated and simulated parameters, using the material properties of Table 1, are listed in Table 2 and, in general, show good agreement. Notice that the thermal capacitance values obtained by FE simulations show a small discrepancy as they increase with decreasing sensor mass. This is most likely due to the time constant estimation, which is more susceptible to errors as it decreases.

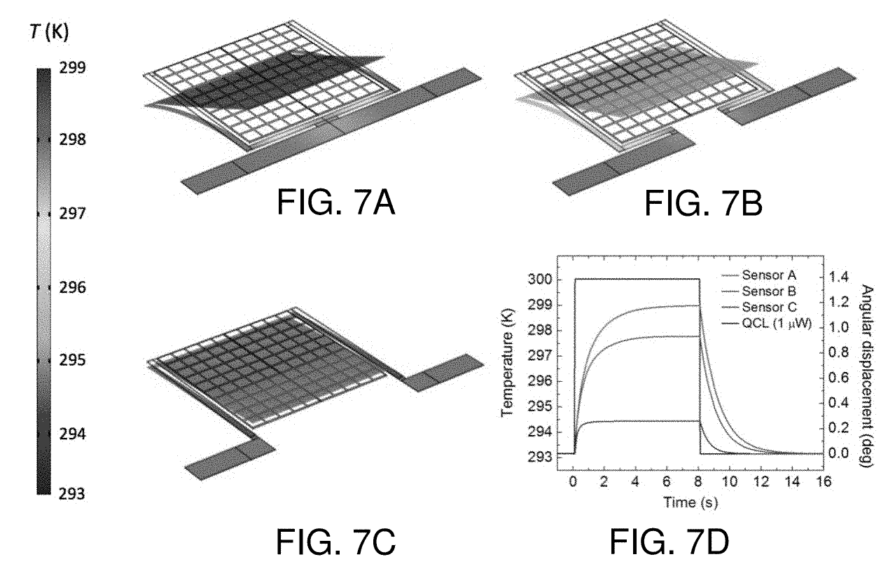

FIGS. 7A-7C show the deformation plots obtained by FE simulation of sensors A, B, and C, respectively, under a constant 1 μW heat flux, where the z-axes are scaled up 20 times for visual purposes. The surface color scale indicates the temperature distribution and it is the same for all sensors. It can be seen in FIGS. 7A-7C that sensor A deflects more compared to sensors B and C under the same incident power (1 μW) primarily due to lower thermal conductance. FIG. 7D shows the time domain simulations where the sensors are submitted to a step excitation (black solid line) of 1 μW for duration of 8 seconds. The vertical axes show temperature on the left side and angular deflection on the right side. Temperature change and angular displacement are shown on the left and on the right, respectively.

Noise sources intrinsic to the detectors were also considered and an analysis similar to that in “Performance of uncooled microcantilever thermal detectors,” Rev. Sci. Instrum. 75(4), 1134-1148 (2004) by P. G. Datskos, N. V. Lavrik, and S. Rajic, herein incorporated by reference, was performed to determine the NEP. The expressions given by Eqs. (6) and (7) were adapted from the same article to reflect angular deflection fluctuations.

The primary noise sources in thermal detectors are temperature fluctuation, background fluctuation and thermomechanical noises. The spontaneous fluctuation in angular deflection (deg) of the absorbers caused by temperature fluctuations is given by

$${〈 {δθ}_{TF}^{2} 〉}^{1 / 2} = \frac{( d θ / dP ) T \sqrt{4 {k}_{B} GB}}{η} , \qquad ( 6 )$$

where T is the sensor temperature, k_{B} is the Boltzmann constant, G is the total thermal conductance and B is the bandwidth, which can be set to unity. The background fluctuation noise can be obtained by replacing the total thermal conductance in Eq. (6) by thermal conductance via radiation loss of heat. However, this is much smaller than the thermal conductance via the bi-material legs and its contribution to noise can be neglected. The angular deflection (deg) due to thermomechanical noise, knowing that the detector operating frequency is much slower than the mechanical resonances (few kHz), is given by

$${〈 {δθ}_{TM}^{2} 〉}^{1 / 2} = \frac{360}{π {l}_{b}} \sqrt{\frac{4 {k}_{B} TB}{Qk {ω}_{0}} ,} \qquad ( 7 )$$

where Q is the quality factor, k is the stiffness and ω₀ is the resonant angular frequency of the mechanical structure. Using the eigenfrequency solver in the COMSOL structural mechanics module, the first resonant frequency and stiffness of all the sensors were estimated and found to have values 3.5, 4.0 and 6.0 kHz and 0.02, 0.025 and 0.04 Nm⁻¹ for sensors A, B and C respectively. Typical Q values for similar structures lie between 100 and 1000 in vacuum. The noise was estimated and as expected, the dominant source is the temperature fluctuation in the detector. The total noise intrinsic to the sensors was estimated to be 5.0, 4.0 and 2.0 μdeg. The NEP values of the three sensors were calculated by dividing the fluctuations due to the noise by their respective responsivities, and are listed in Table 2.

Fabrication and Characterization

The bi-material THz sensors were fabricated using standard micromachining technology. First, a 100 nm thick aluminum (Al) film was deposited on a 300 μm thick silicon (Si) substrate by e-beam evaporation. Then, the Al layer was patterned and wet etched to form the absorber ground plane. Next, a 1.1 μm thick SiOₓ layer was deposited using plasma enhanced chemical vapor deposition (PECVD) at 300° C., followed by another 100 nm thick Al film. The second Al layer was then patterned and plasma etched to define the absorber metamaterial squares. Then a 170 nm thick Al layer was deposited, patterned and lifted off to form the bi-material legs. The sensor structure was then created by reactive ion etching of the SiOₓ layer. Finally, the structures were released through backside trenching using the Bosch etch process. Circular openings were chosen to ensure release of the structure and to help refine the Bosch etch recipe.

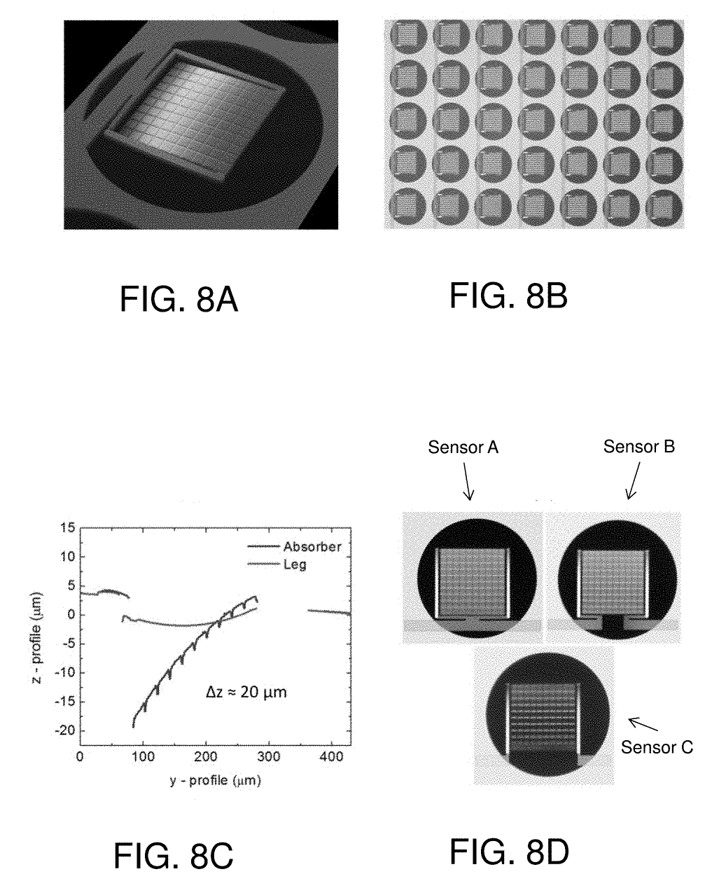

FIGS. 8A, 8B, 8D illustrate embodiments of fabricated THz bi-material sensors in accordance with the invention. FIG. 8A illustrates a 3D optical profile of one embodiment of sensor A (the aspect ratio is preserved). FIG. 8B illustrates a micrograph of an array of a plurality of sensors A. FIG. 8C illustrates a 2D profile of the sensor in FIG. 8A, taken along the bi-material legs direction (y-profile) with the processing direction (z-profile) scale exaggerated to show the residual deflection of the legs (red line) and absorber (blue line). FIG. 8D illustrates micrographs showing a top view of sensors A, B and C. The measured residual deflection of the metamaterial absorber is approximately 6° for the sensors A and B and 8° for sensor C. It is easy to observe that the metamaterial absorber is almost flat due compensation of stresses from the aluminum layers in both sides of the SiOₓ layer. Due to the deflection of the sensors, micrographs shown in FIG. 8D are not completely focused across the surface. In addition to the sensors, the fabricated wafer contains an area of 10×10 mm² filled with the same metamaterial structure used in the sensors. This is to allow accurate measurement of the absorption characteristics of metamaterial used in the sensors.

TABLE 2
THz bi-material sensor analytical numerical and experimental parameters.

| | Sensor | | | | | | | | |
|---|---|---|---|---|---|---|---|---|---|
| | Sensor A | | | Sensor B | | | Sensor C | | |
| Property | Anal. | FE | Exp. | Anal. | FE | Exp. | Anal. | FE | Exp. |
| Absorptance η | — | 0.96 | 0.95 | — | 0.96 | 0.95 | — | 0.96 | 0.95 |
| Thermal Conductance | 1.6 | 1.7 | — | 2.2 | 2.1 | — | 9.3 | 8.5 | — |
| G (×10⁻⁷ W K⁻¹) | | | | | | | | | |
| Thermal Capacitance | 11.1 | 12 | — | 10.7 | 12.5 | — | 9.8 | 11.9 | — |
| C (×10⁻⁸ J K⁻¹) | | | | | | | | | |
| Time constant | 0.68 | 0.7 | 0.8 | 0.47 | 0.6 | 0.5 | 0.1 | 0.14 | 0.3 |
| τ (s) | | | | | | | | | |
| Thermomechanical | 0.15 | 0.19 | 0.2 | 0.15 | 0.2 | 0.2 | 0.15 | 0.2 | 0.2 |
| Sensitivity | | | | | | | | | |
| dθ/dT (deg K⁻¹) | | | | | | | | | |
| Responsivity | 0.95 | 1.1 | 1.2 | 0.65 | 0.9 | 0.8 | 0.15 | 0.25 | 0.2 |
| dθ/dP (×10⁶ deg W⁻¹) | | | | | | | | | |
| Noise Equivalent Power | 0.005 | — | 8.6 | 0.006 | — | 13 | 0.014 | — | 45 |
| (due to incident power) | | | | | | | | | |
| NEP (×10⁻⁹ W) | | | | | | | | | |

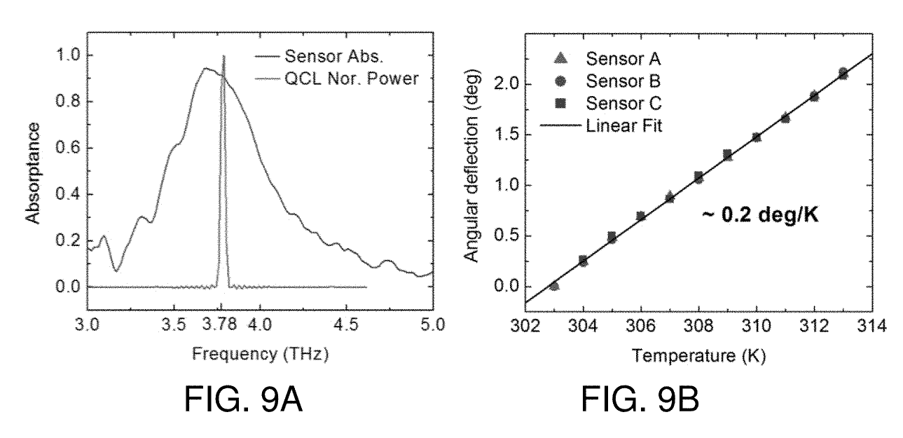

FIG. 9A illustrates measurement of the absorptance spectra of the THz sensors metamaterial structure (blue line) compared with the QCL normalized emission (read line). The absorptance of the metamaterial film was measured as earlier described and compared with the QCL emission characteristics as shown in FIG. 9A. A good match between the absorptance peak position of the metamaterial and the 3.8 THz QCL emission frequency was achieved with nearly 95% absorptance. This assured that the sensors absorbed the QCL emission with high efficiency.

Next, the thermal response of the sensor (dθ/dT) was measured. The temperature gradient in the bi-material section of the leg was estimated to be less than 5% of that between the central absorbing element and the substrate. Thus, the bi-material section of the leg can be treated as thermally shorted allowing the measurement of the thermal response by uniformly heating the sensor. The measurement was performed by attaching the sensor to a flat resistive heating element and sweeping the temperature from 303 to 313 K. The reflection of a laser diode beam from the backside of the sensor's ground plane was projected on a screen and the angular deflection of the sensor was determined. Angular deflections from the three sensors are shown in FIG. 9B with different markers. The deflections are almost indistinguishable because the detectors have the same bi-material leg dimensions. The solid line is a linear fit, showing that the response in this temperature range is linear and approximately 0.2 deg/K, which is slightly higher than the estimated values (see Table 2 and FIG. 2). FIG. 2 shows that the thermal response of the sensors can be further increased by, for example, decreasing the SiOₓ thickness or increasing the Al thickness on the bi-material legs. Test structures fabricated in parallel with these sensors showed that increasing the Al thickness on the bi-material legs also increases the residual stress. Decreasing the dielectric thickness has a similar effect in addition to reducing absorber efficiency. In additional embodiments, it is expected that adjustments to the fabrication process, such as adjustment of the SiOₓ thickness and Al thickness on the bi-material legs, can be implemented to reduce the residual stress on the bi-material legs to decrease the initial bending as depicted in FIG. 8A.

Subsequently, the sensors were placed in a vacuum chamber and operated at a pressure of approximately 0.03 mTorr to minimize the heat loss by convection [29]. The QCL was kept inside a cryostat and operated at around 15 K. The divergent THz beam passed through the cryostat Tsurupica window and the radiation was focused by a 40 mm polyethylene lens onto the sensors. Both Tsurupica and polyethylene exhibit reasonable transmission (˜65%) in the THz range. The QCL was operated in pulsed mode with the pulse width fixed at 5 μs and a variable pulse rate to control the output power. The deflection of the sensor was measured using the same procedure described earlier for a set of QCL pulse rates ranging from nearly zero to 5 kHz. The absolute power that reaches the sensors (incident power) is estimated using the responsivity (dθ/dP) in Eq. (2) along with the calculated thermal conductance and measured absorptance. Note that the QCL switching frequency and duty factor must be taken into account since the sensors can only respond to the average power.

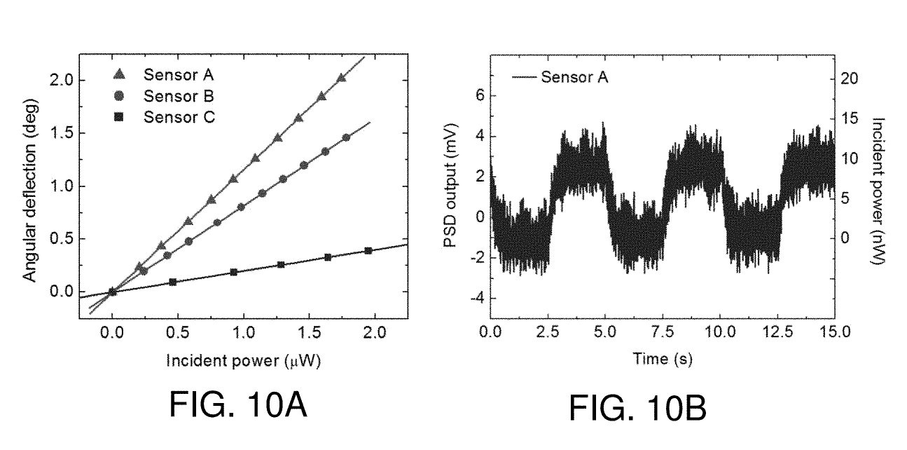

FIGS. 10A-10B illustrate responsivity and NEP measurements. FIG. 10A illustrates the measured angular deflection versus incident power for all three sensors A, B, and C (colored markers). For all of the sensors, the responsivity values estimated analytically tend to be lower than that of the FE and experimental values mainly due to the underestimation of bimetallic effect (dθ/dT), by Eq. (3) (see FIG. 2). As expected from Eq. (2), responsivity of the sensors was found to decrease with increasing thermal conductance.

To determine NEP, a position-sensing detector (PSD) was added to the experimental setup to read the deflection at low power levels. The NEP was then measured for each detector and listed in Table 2. FIG. 10B shows measured output voltage of the PSD for sensor A by gating the QCL output at 0.2 Hz. The power incident in the detector is shown on the right vertical axis. It is important to highlight that the measurements include the effects of QCL power fluctuations and optical readout noise, not considered in the theoretical estimations discussed earlier. The difference between the measured values (3 orders of magnitude higher) and the estimated ones (Table 2) can be attributed primarily to the readout noise. The QCL power fluctuations do not seem to contribute to the observed noise since the noise floor when the QCL is off, shown in FIG. 10B is similar to the noise observed when the QCL is on. As expected, NEP increases from sensor A to C due to decrease in responsivity. The measured NEP values, including the readout noise and the intrinsic noise of the sensor, can be translated into minimum detectable temperature difference on the sensor, found to be approximately 50 mK for all three sensors. This value is similar to those of bi-material sensors operating in the IR range.

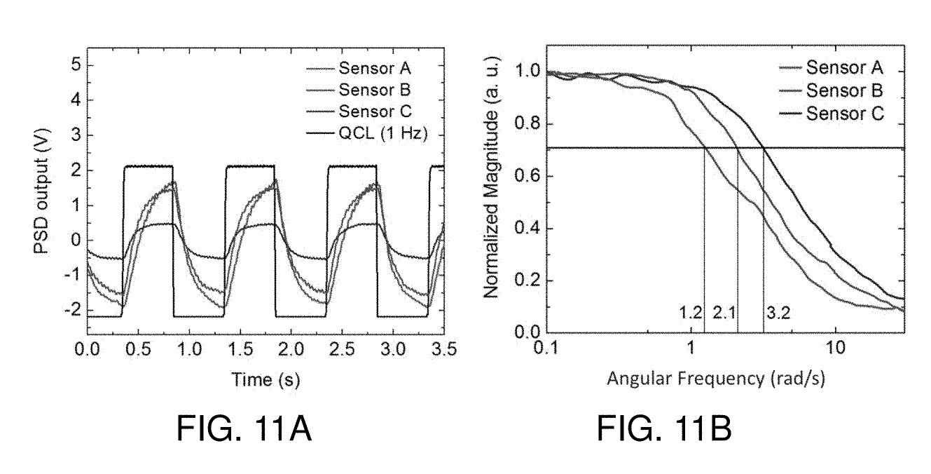

The time domain response was also measured using the PSD and the results for the three sensors A, B, and C are shown in FIG. 11A under the same incident power. As observed in FIG. 11A, sensor A is more sensitive, which agrees with the predictions and previous measurements. Since the sensors have the same η, the same absorbing area, same materials, the same dθ/dT, and nearly the same thermal capacitance, speed and responsivity are completely controlled by the thermal conductance, which depends on the anchor geometry. The time constant of the sensors was determined by sweeping the QCL gating frequency from 50 mHz to 30 Hz and recording the PSD peak to peak voltage.

The normalized frequency responses for the three sensors (colored lines) are shown in FIG. 11B. The time constants were retrieved by taking the inverse of the 3 dB frequencies that are 1.2, 2.1 and 3.2 rad/s for sensors A, B and C respectively, and included in Table 2. In general, the measured time constants agree well with the FE estimations, while the analytical approach underestimates this parameter.

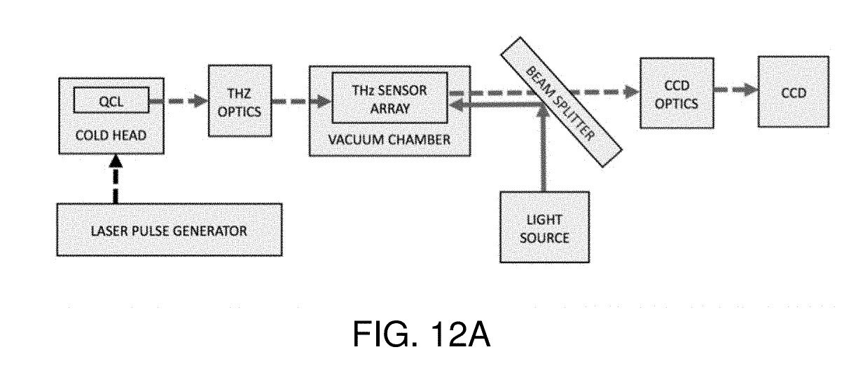

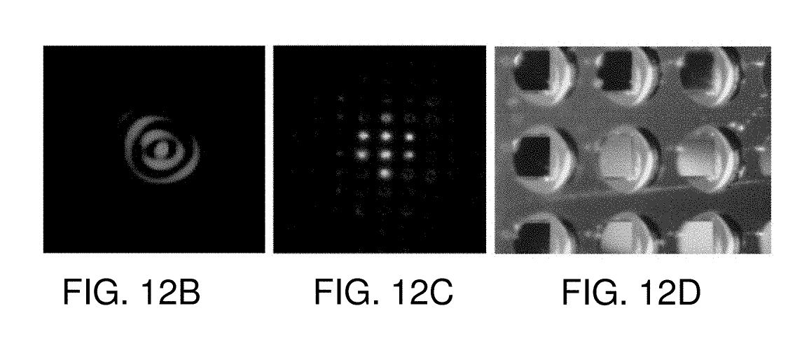

Although the fabricated bi-material THz sensor arrays do not have high spatial resolution, their imaging capabilities were probed by a CCD camera with coaxial illumination as schematically illustrated in FIG. 12A. FIG. 12A illustrates optical readout used to record videos and the snap shot shown in FIG. 12C. The images were recorded using background subtraction to suppress to the effects of the residual stress of the sensors. FIG. 12B illustrates an image obtained using a 30 μm pitch commercial IR microbolometer camera with THz optics.

FIG. 12C illustrates a snap shot of an image obtained using an array of sensor A with 430 μm pitch using the readout depicted in FIG. 12A. Notice that since the pitch of sensor A is one order of magnitude higher than the IR camera, sensor A cannot resolve the rings associated with the QCL beam, shown in FIG. 12B. The focal plane array of the IR camera has 30 μm pitch of and can resolve the rings associated with the QCL beam. The array of sensor A, on the other hand, has a 430 μm pitch and cannot resolve the rings; nevertheless, the array of sensor A gives a raw image that clearly shows where the energy is concentrated and the circular shape of the THz beam. FIG. 12D illustrates a close up of sensor A as seen by the optical readout. Thus as detailed herein, embodiments in accordance with the invention allow optimization of the THz bi-material sensor materials, configuration, size, fabrication processes, and readout to achieve real time imaging.

Herein the design, fabrication and characterization of bi-material sensors, using metamaterial absorbers operating in THz range have been detailed. Sensor materials and configurations were chosen in order to maximize responsivity. The combination of favorable thermal, mechanical and optical properties of the microelectromechanical system (MEMS) fabrication-friendly materials SiOₓ and Al were advantageous. Analytical and FE models were used to predict the performance of the sensors. A highly efficient metamaterial structure was developed to provide near 100% absorption at 3.8 THz, while simultaneously serving as a structural layer and providing access for external optical readout. The fabricated bi-material THz sensors showed responsivity values as high as 1.2 deg/μW and time constants as low as 200 ms, depending on the configuration. Minimum detectable power on the order of 10 nW was observed, demonstrating that the bi-material THz sensors can operate with low-power THz sources. Although the bi-material THz sensors were not optimized for imaging, the use of an external optical readout allowed raw images of the QCL beam to be obtained indicating the potential of these bi-material THz sensors to be further optimized for use in focal plane arrays for real time THz imaging.

THz Emitter

In a further embodiment, metamaterial structure 308 shown in FIGS. 3A, 3B can act as a THz emitter rather than an absorber. When metamaterial structure 308 is heated up, instead of emitting the full blackbody spectrum of electromagnetic radiation it essentially has very low (approximately zero) emissivity at frequencies other than its resonant frequency and perfect emissivity (emissivity of 1) at the desired frequency. In this case, while aluminum-silicon dioxide pair shows good properties, the thermal expansion coefficient discrepancy is not so critical so a choice of conductive and dielectric materials is wider. Use of polymers and epoxies, such as SU-8 negative photoresist is also a viable choice.

Selectively heating an array of metamaterial pixels, for example by attaching micro-heater to each pixel can be used for projecting a THz scene. These scene generators can be used for testing the performance of THz focal plane arrays made of high THz absorbing metamaterials as well as in spectroscopic applications.

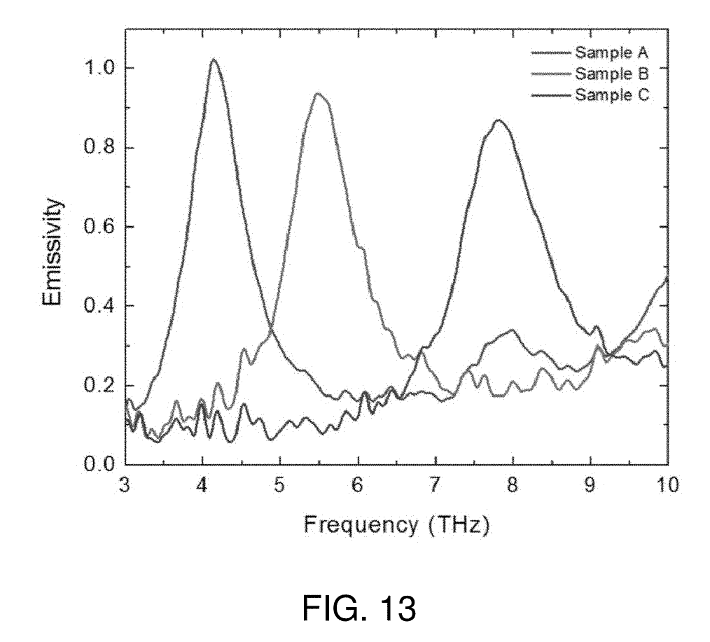

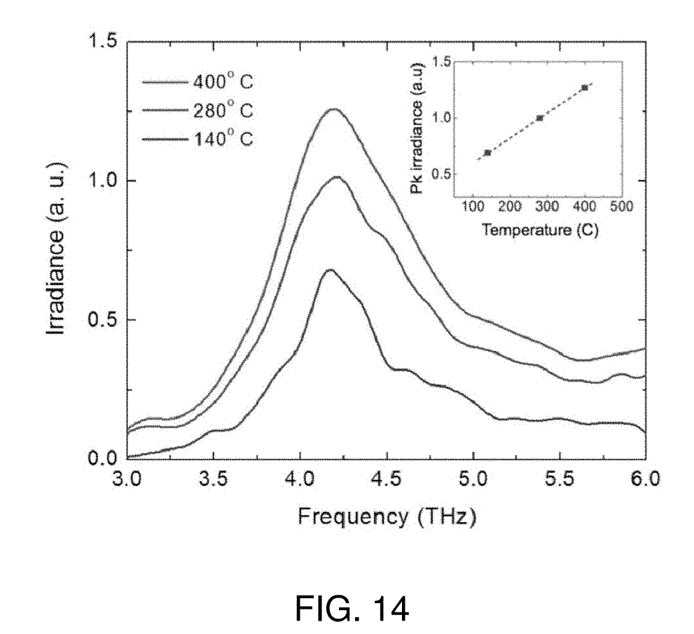

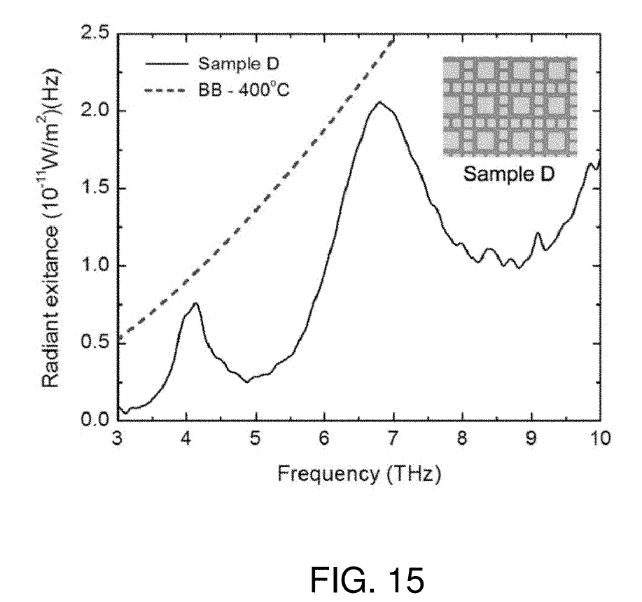

FIGS. 13 through 15 show the experimental measurements of the emission metamaterial sample when heated in accordance with one embodiment. FIG. 14 illustrates the spectral irradiance of Sample A, measured at 140, 280 and 400° C. The inset in FIG. 14 shows that the measured peak emission (solid squares) depends linearly with temperature (solid line). FIG. 15 further shows that the metamaterial acts as a “filter” to the blackbody radiation passing only the radiation at the metamaterial's resonant frequency. The inset of FIG. 15 shows the metamaterial pattern with two different size squares (10 and 18 μm) distributed in a tile like arrangement.

This disclosure provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

In both applications, i.e., THz absorber and THz emitter, other conductive materials can be used, such as, aluminum, gold, copper, silver, platinum, titanium, chromium, nickel, polysilicon, graphene, carbon compounds, and other conductive material, as well as other dielectrics such as, silicon dioxide, silicon nitride, silicon oxinitrides, polyimide, polysilicon, silicon or other insulating material.

This disclosure provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

What is claimed is:

1. A bi-material terahertz (THz) sensor comprising:
a metamaterial absorber;
a first bi-material leg connected to the metamaterial absorber;
a second bi-material leg connected to the metamaterial absorber;
one or more anchor structures connecting the first bi-material leg and the second bi-material leg to a substrate; and
a substrate.

2. The bi-material THz sensor of claim 1 wherein the metamaterial absorber comprises:
an electrically conductive ground plane layer;
an electrically insulating dielectric layer in communication with the electrically conductive ground plane layer; and
a plurality of electrically conductive surface elements formed on the dielectric layer and in communication with the dielectric layer.

3. The bi-material THz sensor of claim 2 wherein the ground plane is reflective to allow external optical readout.

4. The bi-material THz sensor of claim 1 wherein the one or more anchor structures thermally insulate the first and second bi-material legs from the substrate.

5. The bi-material THz sensor of claim 4 wherein the one or more anchor structures have a lower thermal conductance than the first and second bi-material legs.

6. The bi-material THz sensor of claim 1 wherein the one or more anchor structures comprise:
an anchor structure, wherein the anchor structure is connected to the first bi-material leg and the second bi-material leg and to the substrate.

7. The bi-material THz sensor of claim 1 wherein the one or more anchor structures comprise:
a first anchor structure, wherein the first anchor structure is connected to the first bi-material leg and to the substrate; and
a second anchor structure, wherein the second anchor structure is connected to the second bi-material leg and to the substrate.

8. A bi-material terahertz (THz) sensor for detecting THz radiation comprising:
a metamaterial absorber for absorbing terahertz radiation and for converting the absorbed terahertz radiation into heat;
a first bi-material leg connected to the metamaterial absorber, wherein the first bi-material leg is connected at a first end to the metamaterial absorber and at a second end to an anchor structure;
a second bi-material leg connected to the metamaterial absorber, wherein the second bi-material leg is connected at a first end to the metamaterial absorber and at a second end to an anchor structure;
one or more anchor structures connected to the second end of the first bi-material leg and the second end of the second bi-material leg and to a substrate; and
a substrate.

9. The bi-material THz sensor of claim 8 wherein the metamaterial absorber comprises:
an electrically conductive ground plane layer;
an electrically insulating dielectric layer in communication with the electrically conductive ground plane layer; and
a plurality of electrically conductive surface elements formed on the dielectric layer and in communication with the dielectric layer.

10. The bi-material THz sensor of claim 9 wherein the ground plane is reflective to allow external optical readout.

11. The bi-material THz sensor of claim 8 wherein the one or more anchor structures thermally insulate the first bi-material leg and the second bi-material leg from the substrate.

12. The bi-material THz sensor of claim 11 wherein the one or more anchor structures have a lower thermal conductance than the first bi-material leg and the second bi-material leg.

13. A bi-material terahertz (THz) sensor for detecting THz radiation comprising:
a resonant metamaterial absorber for absorbing incident terahertz radiation and converting the absorbed THz radiation into heat, wherein the metamaterial absorber comprises:
an electrically conductive ground plane layer;
an electrically insulating dielectric layer in communication with the electrically conductive ground plane layer; and
a plurality of electrically conductive surface elements formed on the dielectric layer and in communication with the dielectric layer;
bi-material legs, in connection with the metamaterial absorber, the bi-material legs for undergoing deformation when heated by the metamaterial absorber, wherein the bi-material legs comprise:
a continuous electrically conductive layer; and
an insulating layer extending from the electrically insulating dielectric layer in the metamaterial absorber; and
a thermal insulating anchor structure, extending from the electrically insulating dielectric layer from the metamaterial absorber and the bi-material legs, for connecting the metamaterial absorber and the bi-material legs to a substrate and for providing thermal insulation, allowing a temperature gradient to form between the metamaterial absorber and the substrate such that the substrate performs as a heat sink.

14. The bi-material THz sensor of claim 13 wherein the metamaterial absorber has a resonant absorption band for selectively absorbing incident terahertz responsive to a resonant electromagnetic coupling between the plurality of surface elements and the continuous electrically conductive layer in the bi-material legs.

15. The bi-material THz sensor of claim 13 wherein the bi-material legs are comprised of the same electrically conductive layer and isolating dielectric layer materials used in the metamaterial absorber.

16. The bi-material THz sensor of claim 13, wherein the deformation of the bi-material legs is proportional to the amount of heat provided by the metamaterial absorber and proportional to the amount of absorbed terahertz radiation.

17. The bi-material THz sensor of claim 13, wherein the anchor structure is comprised of the same material as the insulating dielectric layer in the metamaterial absorber and the bi-material legs.

18. A THz emitter for emitting THz radiation comprising:
an electrically conductive ground plane layer;
an electrically insulating dielectric layer in communication with the electrically conductive ground plane layer; and
a plurality of electrically conductive surface elements formed on the dielectric layer and in communication with the dielectric layer,
wherein when the THz emitter is heated by an external source, the THZ emitter converts the heat into THz radiation, and emits the THz radiation.
